(19) United States
(12) Patent Application Publication
(10) Pub. No.: US 2012/0279009 A1
(43) Pub. Date: Nov. 8, 2012

(54) Plug Connection Between a Wiper Blade and a Wiper Arm

(75) Inventors: Thomas Erney, Hamburg (DE); Holger Fitterer, Rheinstetten (DE); Alexander Mittler, Sindelfingen (DE); Rainer Schlageter, Deckenprofronn (DE); Michael Schulze, Gaeufelden (DE); Jan Urban, Gaertringen (DE)

(73) Assignee: Daimler AG, Stuttgart (DE)

(21) Appl. No.: 13/516,956

(22) PCT Filed: Nov. 5, 2010
(86) PCT No.: PCT/EP2010/006754

§ 371 Date: Jul. 25, 2012

(30) Foreign Application Priority Data
Dec. 19, 2009 (DE) 102009059121.4

(51) Int. Cl. B60S 1/40

(52) U.S. Cl. 15/250.32

(57) ABSTRACT

A plug connection between a wiper blade and a wiper arm of a wiper mechanism for a windscreen of a vehicle is provided. A bolt standing laterally away from the wiper arm can be introduced into a socket. The bolt includes a recess extending in the direction of the middle axis of the bolt. When the socket is pushed onto the bolt, a raised element extending in radial direction and arranged on an inner wall of the socket can be guided along the recess. The recess includes an extension region, into which the raised element can be brought by twisting the bolt and the socket relative to each other. A stop limiting the twisting is formed in the extension region between the bolt and the socket. A locking position of the socket is thus precisely defined.

### BACKGROUND AND SUMMARY OF THE INVENTION

Exemplary embodiments of the present invention relate to a plug connection between a wiper blade and a wiper arm with a bolt that can be introduced into a socket. The bolt includes a recess extending in axial direction. A raised element extending in the radial direction and arranged on an inner wall of the socket can be guided along the recess. The recess includes an extension region, into which the raised element can be brought by twisting the bolt and the socket relative to each other.

German Patent Document DE 26 29 546 A1 describes a wiper arm with a bolt standing laterally away from it. The bolt comprises an annular groove between two regions with equal diameter. A continuous slot is incorporated into the bolt going from an end face of the bolt as far as the annular groove. A mounting bracket of a wiper blade has a U-profile in cross-section, whereby two concentric holes aligned with each other are provided in side cheeks of the mounting bracket, which holes serve as a receiving element for the bolt. A rectangular metal element is sheared out of the back of the mounting bracket and angled so that it projects radially into the space between the two holes. Upon introduction of the bolt through one of the concentric holes, the metal plate element slides along in the slot extending in axial direction until it reaches the area of the annular groove. The mounting bracket of the wiper blade can then be twisted relative to the bolt and thus relative to the slot. End faces of the metal plate element hereby lie against the side walls of the annular groove. After twisting, the wiper blade is held in a secure position in axial direction on the wiper arm. However, during operation of the wiper arm the wiper blade and wiper arm may twist relative to each other, whereby the metal plate element slides along in the annular groove.

Further possibilities for fixing a wiper blade on a bolt standing laterally away from a wiper arm of a wiper mechanism for motor vehicle windscreens are described in German Patent Documents DE 102 59 477 A1 and DE 103 43 571 A1. Here, the bolt comprises at least one raised element projecting in radial direction that is guided along in a corresponding wiper-blade-side socket upon connection of the wiper blade and wiper arm. The wiper mechanism is then locked in the manner of a bayonet closure by twisting the wiper-blade-side socket relative to the bolt.

A disadvantage of conventional plug devices is the fact that a secure locking is at times difficult to manage for an operator.

Exemplary embodiments of the present invention provide a plug connection that facilitates particularly simple and secure locking.

In the plug connection according to exemplary embodiments of the present invention, a bolt is provided between a wiper blade and a wiper arm which can be introduced into a socket. The bolt comprises a recess extending in axial direction, along which a raised element extending in radial direction and arranged on an inner wall of the socket can be guided. The recess comprises an extension region, into which the raised element can be brought by twisting the bolt and the socket relative to each other. At least one stop limiting the twisting movement is hereby formed in the extension region between the bolt and the socket.

Due to the fact that the raised element on the inner wall of the socket can be guided along the recess formed in the bolt, a simple guided connection of two components, which can be twisted relative to each other, is facilitated. According to the principle which is called “poka yoke” in Japanese and means “avoid avoidable errors” the pushing of the component comprising the socket onto the component comprising the bolt is only possible with a predefined orientation of the components relative to each other.

A twisting of the bolt and the socket relative to each other is facilitated once the raised element reaches the extension region of the recess. The stop limiting the twisting between the bolt and the socket then ensures that an operator can intuitively detect when an orientation of the bolt and socket relative to each other is reached, in which the bolt and socket are securely locked. Anti-twisting protection is hereby advantageously simultaneously provided through the stop.

Preferably merely one stop is formed which characterizes this orientation of the bolt and socket relative to each other, wherein it can be an end position. In this orientation the components comprising the bolt and the socket are then locked relative to each other. The plug connection thus facilitates a particularly simple and secure locking of a wiper blade relative to a wiper arm.

In an advantageous embodiment of the invention the recess comprises at least in areas in cross-section three corner points. In particular the three corner points can be the corner points of a sector of a circle if the bolt is formed at least substantially circularly cylindrically. Such a recess facilitates a particularly precise guiding of the raised element along the recess.

It has been shown to be further advantageous if two side flanks of the recess incorporate at least in areas a right angle running together in particular in a middle axis of the bolt. A comparatively large recess is thus provided that is particularly suited as a guide for a likewise large and thus stable raised element.

In a further advantageous embodiment of the invention the extension region is formed in cross-section as a segment of a circle. The segment of a circle can preferably contact a middle axis of the bolt. Only a limited twisting is thus necessary for formation of the stop between the bolt and the raised element, namely in dependence upon the size of the raised element by a maximum of somewhat less than 180°.

It has proved to be further advantageous if the recess comprises a form corresponding to the raised element in a length region deflecting from the extension region. Upon guiding the raised element along the length region of the recess only a single orientation of the components comprising the socket and the bolt relative to each other is possible. The poka yoke principle is then particularly extensively realized. In particular, if the raised element has a cross-sectional form of a quarter of a circle a particularly exact and simple guiding of the raised element along the recess is facilitated. If the extension region has a cross-sectional form of a semi-circular segment a twisting of the bolt and socket relative to each other upon reaching the extension region by merely 90° facilitates a secure locking which can be particularly simply detected intuitively by the operator.

In a further advantageous embodiment of the invention the wiper blade is brought into a work position relative to the wiper arm by bringing a stop surface of the raised element into abutment with a stop surface of the bolt. The provision of a planar stop thus facilitates a particularly exact and easily reproducible predefining of the work position.

The plug connection can comprise at least a releasable anti-twisting protection means, in particular detent means, by means of which twisting of the bolt and the socket relative to each other can be suppressed. This releasable anti-twisting protection means preferably secures the bolt and socket relative to each other in the work position. First, the releasable anti-twisting protection means is then to be released to unlock the plug connection before a twisting of the bolt and the socket relative to each other can take place in a direction contrary to the locking direction.

A push button that can be radially pushed in can be provided on the bolt as a releasable detent means, which push button can be introduced into a corresponding opening in the socket. Before rotating the socket back in relation to the bolt until axial alignment of the raised element and recess is achieved the push button must then be initially activated.

In a further advantageous embodiment of the invention a friction locking and/or a shape locking connection is formed between the bolt and the socket to prevent a gravity-related twisting of the bolt and the socket relative to each other. This ensures that even if the wiper blade is not in abutment with a surface to be wiped, for example a windscreen of a vehicle, a twisting of the bolt and socket relative to each other requires a force exceeding gravity which then overcomes the friction locking connection and/or the shape locking connection.

The bolt is preferably arranged on the wiper arm, in particular pointing in a wiping direction of the wiper blade. If the bolt points in the wiping direction the clearance-free fixing of the socket on the bolt in the locking position is advantageous for carrying out the wiping movement. Correspondingly the socket is then arranged on the wiper blade, whereby the socket can be formed integrally with a support arm of the wiper blade. In such an arrangement when the wiper blade is changed the stable bolt is provided on the wiper arm remaining on the vehicle, whereby a good durability of the plug connection can be achieved.

Finally, it has proved advantageous if the bolt and/or the socket comprise(s) at least one line for washing liquid and/or at least one heating element. One or more lines for washing liquid facilitate a targeted application of the washing liquid in direct proximity to the wiper blade carrying out the wiping. By means of the heating element the wiper blade and/or the washing liquid can be heated. Persistent soiling of the surface to be wiped, in particular the windscreen of the vehicle, and/or ice on the surface can thereby be removed particularly effectively and with sparing use of washing liquid.

The features and feature combinations mentioned above in the description and the features and feature combinations mentioned below in the description of the drawings and/or shown solely in the drawings can be used not only in the respectively indicated combination but also in other combinations or alone without going outside of the scope of the invention.

### BRIEF DESCRIPTION OF THE DRAWING FIGURES

Further advantages, features and details of the invention follow from the claims, the following description of preferred embodiments and by reference to the drawings, in which:

FIG. 1 shows a perspective view of a bolt arranged on a wiper arm of a wiping mechanism for wiping a vehicle windscreen, which bolt is part of a plug connection;

FIG. 2 shows the plug connection in a perspective view, wherein a socket arranged on a wiper blade is pushed onto the bolt according to FIG. 1 and conveyed into a work position of the wiper mechanism; and

FIG. 3 shows the plug connection according to FIG. 2 in another perspective view.

### DETAILED DESCRIPTION

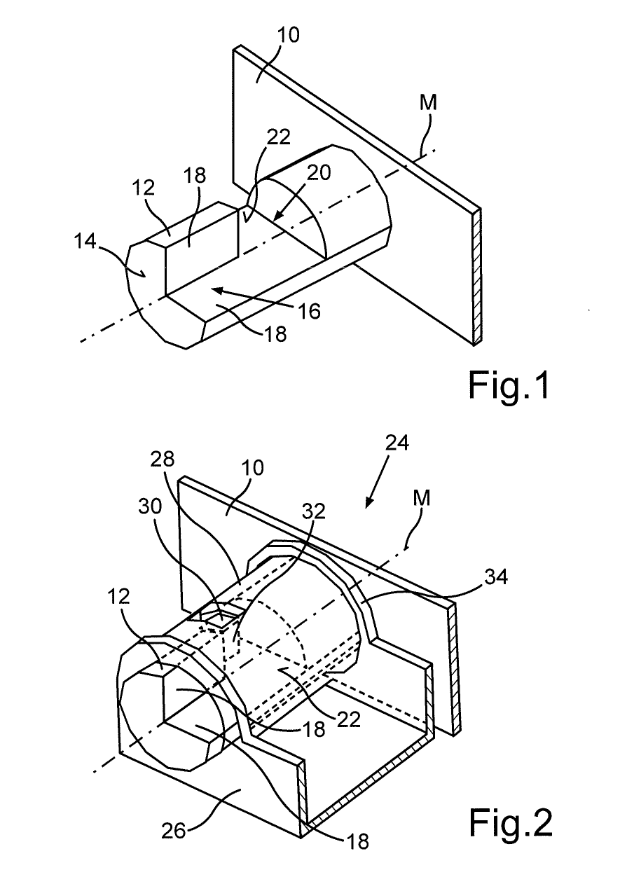

FIG. 1 shows, in a cut-out, a wiper arm 10 of a wiper mechanism for a windscreen of a vehicle. A bolt 12 standing perpendicularly away from the wiper arm 10 is laterally arranged on the wiper arm 10. The bolt 12 comprises, starting from its end face 14 lying opposite the wiper arm 10, a recess 16 extending in the direction of its middle axis M. Two side flanks 18 delimit the recess 16, the side flanks run together in the middle axis M at a right angle between them. The recess 16 thus comprises, in the region of the side flanks 18, the form of a quarter of a circle in cross-section.

Starting from the end face 14 the recess 16 comprises an extension region 20 in a length region lying closer to the wiper arm 10. The extension region 20 is formed in cross-section as a semicircular segment. Correspondingly a bottom area 22 is formed planarly in the extension region 20 of the recess 16. The bottom area 22 can be regarded as an extension, extending in the radial direction, of one of the, also planarly formed, side flanks 18.

The bolt 12 is, as follows from FIG. 2, part of a plug connection 24 that serves as the connection of the wiper arm 10 to a support arm of a wiper blade 26, which likewise merely shown in a cut-out. A socket 28 is formed in the support arm of the wiper blade 26, of which the inner diameter corresponds to the outer diameter of the bolt 12 so that the socket 28 can be pushed onto the bolt 12.

A raised element 30 extending in radial direction is arranged on an inner wall of the socket 28, which raised element 30 has the form of a quarter of a circle in cross-section. In order to push the socket 28 onto the bolt 12 the wiper blade 26 must initially be brought into a predefined orientation relative to the wiper arm 10, in which the quarter circle shaped raised element 30 and the recess 16 are aligned with each other in the direction of the middle axis M. Because the pushing of the socket 28 onto the bolt 12 is only possible with a single predefined orientation of the wiper arm 10 and wiper blade 26 relative to each other the coupling of the wiper blade 26 with the wiper arm 10 is realized according to the principle called “poka yoke” in Japanese, which means “avoid avoidable errors”.

When pushing the socket 28 onto the bolt 12 planar side areas 32 of the raised element 30 extending in radial direction slide along on the side flanks 18 of the recess 16. As soon as the socket 28 is pushed so far onto the bolt 12 that the raised element 30 in the direction of the middle axis M is completely in the extension region 20, the wiper blade 26 can be twisted by 90° relative to the wiper arm 10, in the present case anti-clockwise around the middle axis M as a rotation axis.

As soon as the lower side area 32 of the raised element 30 is then in abutment with the bottom area 22 in the extension region 20 of the bolt 12 a stop limiting further twisting is formed between the bolt 12 and the socket 28.

At the same time there is an end-side flange 34 of the socket 28 in abutment with the wiper arm 10 so that no further pushing of the socket 28 onto the bolt 12 is possible in the direction of the middle axis M. An axial slipping of the socket 28 from the bolt 12 contrary to the pushing-on direction is prevented by the raised element 30, of which the end face parallel to the end face 14 of the bolt 12 is in abutment with a corresponding bolt-side abutment area in the extension region 20.

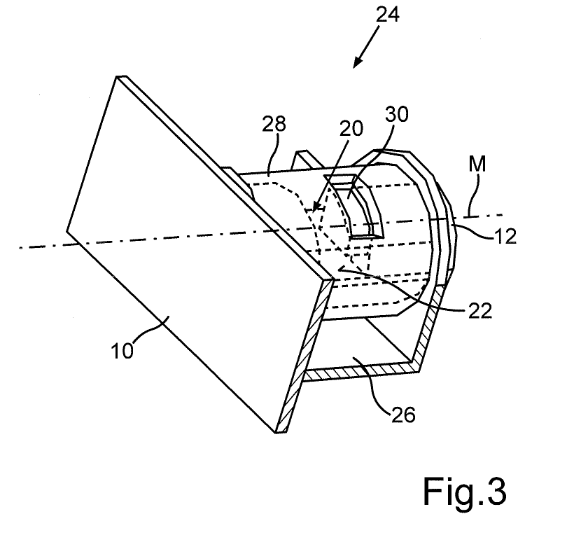

In the work position of the wiper blade 26 shown in FIG. 2 and FIG. 3 the plug connection 24 is locked. In order to release the plug connection 24 a friction locking connection between the bolt 12 and the socket 28 must be overcome and the wiper blade 26 and thus the socket 28 must be twisted by 90°, this time in clockwise direction, around the middle axis M as a rotation axis. The free side area 32, upright in FIG. 2, of the raised element 30 thus comes into abutment with the side flank 18 of the recess 16 in the extension region 20. Only then can the socket 28 be removed along the middle axis M from the bolt 12 and thus the connection between the wiper arm 10 and the wiper blade 26 overcome.

It follows from FIG. 3 that an extension of the raised element 30 in the direction of the middle axis M of the bolt 12 is less than a width of the bottom area 22 in the extension region 20 of the recess 16. Therefore, upon twisting of the wiper blade 26 relative to the wiper arm 10, the end face of the raised element 13 facing the wiper arm 10 does not rub against the semicircular rear wall delimiting the extension region 20 to the rear. The twisting is thus smooth.

In alternative embodiments of the plug connection 24 the extension of the raised element 30 in the direction of the middle axis M of the bolt 12 and the width of the bottom area 22 in the direction of the middle axis M can be of equal size.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-10. (canceled)

11. A plug connection, comprising:
a socket arranged between a wiper blade and a wiper arm; and
a bolt configured for insertion into the socket,
wherein the bolt comprises a recess, extending in an axial direction, configured to guide a raised element that extends in a radial direction and that is arranged on an inner wall of the socket,
wherein the recess comprises an extension region configured such that the raised element can be brought into the recess by twisting the bolt and the socket relative to each other, and
wherein at least one stop, which is configured to limit twisting, is arranged in the extension region of the recess between the bolt and the socket.

12. The plug connection according to claim 11, wherein the recess comprises, at least in areas in cross-section, three corner points of a sector of a circle.

13. The plug connection according to claim 11, wherein two side flanks of the recess incorporate, at least in areas, a right angle running together in a middle axis of the bolt.

14. The plug connection according to claim 11, wherein a cross-section of the extension region has a shape of a segment of a circle that contacts a middle axis of the bolt.

15. The plug connection according to claim 11, wherein the recess comprises, in a length region deflecting from the extension region, a shape corresponding to the raised element.

16. The plug connection according to claim 11, wherein the plug connection is configured such that the wiper blade is brought into a work position relative to the wiper arm by bringing a stop surface of the raised element into abutment with a stop surface of the bolt.

17. The plug connection according to claim 11, wherein the plug connection comprises at least one releasable anti-twisting protection means in the form of detent means, that suppresses twisting of the bolt and the socket relative to each other.

18. The plug connection according to claim 11, wherein a friction locking connection or a shape locking connection is formed between the bolt and the socket, the friction or shape locking connection is configured to prevent a gravity-dependent twisting of the bolt and the socket relative to each other.

19. The plug connection according to claim 11, wherein the bolt is arranged on the wiper arm to point in a wiping direction of the wiper blade.

20. The plug connection according to claim 11, wherein the socket is arranged on the wiper blade by being formed integrally with a support arm of the wiper blade.
